(19) United States
(12) Patent Application Publication
(10) Pub. No.: US 2005/0089816 A1
(43) Pub. Date: Apr. 28, 2005

(54) Dental hand piece

(76) Inventor: Stefan S. Krisch, Corpus Christi, TX (US)

Correspondence Address: GIFFORD, KRASS, GROH, SPRINKLE & CITKOWSKI, P.C, PO BOX 7021, TROY, MI, 48007-7021, US

(21) Appl. No.: 10/970,139

(22) Filed: Oct. 21, 2004

Related U.S. Application Data
(60) Provisional application No. 60/513,636, filed on Oct. 23, 2003.

(51) Int. Cl. A61C 3/02

(52) U.S. Cl. 433/88

(57) ABSTRACT

A dental hand piece is provided for use in conjunction with a source of pressurized water, a source of pressurized gas and a source of abrasive material. The hand piece includes an elongated body having a proximal end and a distal end. An internal mixing chamber is formed within the body and this mixing chamber is fluidly connected to a first outlet port at the distal end of the body by a first passageway. The source of pressurized water is fluidly connected to the mixing chamber by a second fluid passageway formed in the body while the pressurized gas source is fluidly connected by a third fluid passageway in the body to the mixing chamber. A fourth fluid passageway in the body fluidly connects the source of abrasive material to a second port formed at the distal end of the body. The first and second fluid ports are oriented so that the affluent from the first and second ports intersect each other at a predetermined distance from the distal end of the body.

### RELATED APPLICATION

This application claims priority of U.S. Provisional Patent Application Ser. No. 60/513,636 filed Oct. 23, 2003, which is incorporated herein by reference.

### BACKGROUND OF THE INVENTION

I. FIELD OF THE INVENTION

The present invention relates generally to dentistry and, more particularly, to a dental hand piece for use with an abrasive material, a source of pressurized water and a source of pressurized gas.

II. DESCRIPTION OF RELATED ART

Dentists have long used dental hand pieces for various dental procedures. These previously known hand pieces typically include a rotary driven drill, rasp or other implement to perform the dental procedure on a patient's teeth. These dental procedures include, inter alia, removal of caries, tooth preparation for crowns, inlays, facings and the like, as well as other dental procedures.

In recent times, dentists have utilized air abrasive equipment to perform the dental preparation and procedures on the patient's teeth in lieu of the previously known rotary drill. This previously known air abrasive equipment typically comprises a source of pressurized air as well as a source of abrasive material. The abrasive material is intermixed with the air to form an air stream laden with abrasive material. The dentist would then utilize a hand piece through which the abrasive material laden air stream flowed to deliver the air stream to the desired area or work field in the patient's mouth.

These previously known dental hand pieces for delivering the abrasive material laden air stream to the patient's mouth have proven effective for many types of dental procedures. However, such previously known dental hand pieces are inappropriate for other procedures.

For example, such previously known dental hand pieces were oftentimes inappropriate for cleaning the patient's teeth, i.e. the removal of tartar and other material from the teeth. Thus, in order to accomplish such teeth cleaning, the dentist has previously utilized other types of dental hand pieces.

Likewise, during certain dental procedures, the dentist will oftentimes utilize water to rinse the patient's mouth and to clean the work field prior to continuing the dental procedure. In this case, the dentist typically used a water nozzle or spray delivered by a separate implement in order to clean the work field. The intermittent use of the dental hand piece and the water spray, however, increased the length of time necessary for the dentist to perform the dental procedure.

### SUMMARY OF THE PRESENT INVENTION

The present invention provides a dental hand piece which overcomes all of the above-mentioned disadvantages of the previously known devices.

In brief, the dental hand piece of the present invention comprises an elongated body having an internal mixing chamber formed at a distal end of the body. A passageway formed in the hand piece body from the mixing chamber and to the distal end of the hand piece allows effluent to flow from the mixing chamber and out through the port at the distal end of the hand piece.

A second fluid passageway formed in the hand piece body fluidly connects the mixing chamber with a source of pressurized water. Similarly, a third fluid passageway formed through the hand piece fluidly connects a source of pressurized gas, preferably air, to the mixing chamber. A first valve is associated with the pressurized water source to control the flow of water to the mixing chamber while, similarly, a second valve is associated with the pressurized gas source to control the flow of gas to the mixing chamber. With both the first and second valves open, however, the water and gas flow intermix within the mixing chamber and exhaust as an effluent through the port at the distal end of the hand piece body.

A fourth fluid passageway is also formed through the hand piece body. This fourth fluid passageway terminates at one end in a second fluid port at the distal end of the body. The opposite end of the fourth passageway is fluidly connected to a source of pressurized air abrasive material. A valve is associated with the pressurized source of abrasive material so that, when open, abrasive material from the source flows through the fourth passageway and out through the second port at the distal end of the hand piece body. The first and second ports at the distal end of the hand piece body are arranged so that effluent from these ports intersect at a predetermined distance, e.g. one-tenth of an inch, from the distal end of the hand piece body.

A control circuit controls the actuation of the valves associated with the water, gas and abrasive material supply. Thus, by selective actuation of the valves via the control circuit, water, a gas stream laden with abrasive material, a slurry and/or pure gas may be delivered through the hand piece as appropriate for the particular dental procedure.

### BRIEF DESCRIPTION OF THE DRAWINGS

A better understanding of the present invention will be had upon reference to the following detailed description, when read in conjunction with the accompanying drawing, wherein like reference characters refer to like parts throughout the several views, and in which:

FIG. 1 is an elevational view illustrating a preferred embodiment of the present invention;

FIG. 2 is a partial exploded view illustrating a portion of the preferred embodiment of the present invention; and

FIG. 3 is a fragmentary partial sectional view of a portion of the present invention.

### DETAILED DESCRIPTION OF A PREFERRED EMBODIMENT OF THE PRESENT INVENTION

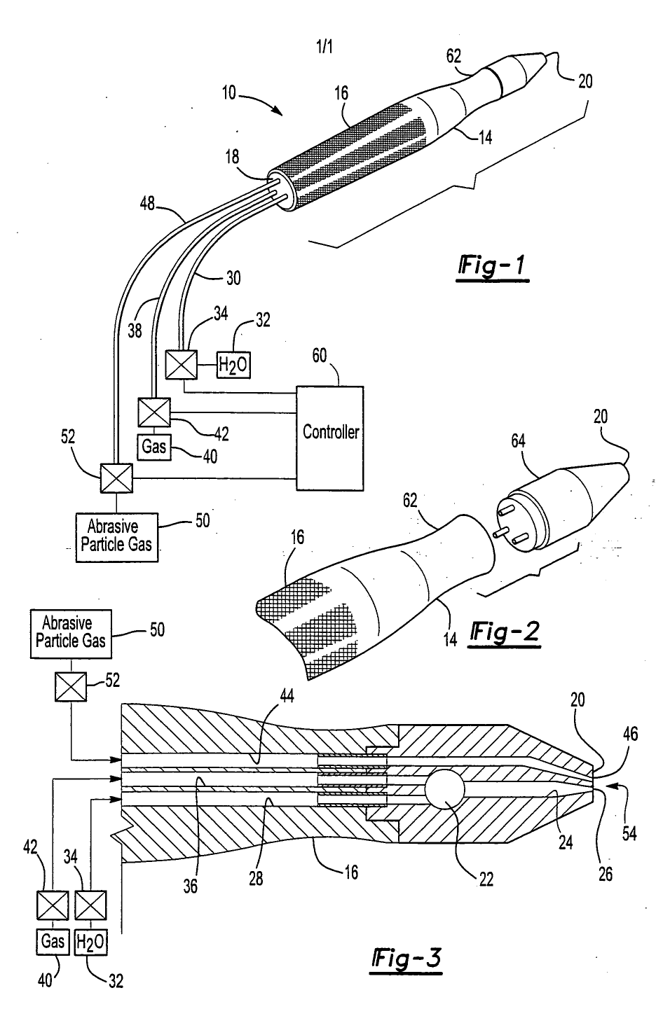

With reference first to FIGS. 1 and 3, a preferred embodiment of the dental treatment system 10 of the present invention is shown for use in treating the teeth of a patient (not shown). The treatment system 10 includes a hand piece 14 having an elongated body 16 with a proximal end 18 and a distal end 20. The body 16 is dimensioned such that it can be continually manipulated by hand by the dentist.

As best shown in FIG. 3, a spherical mixing chamber 22 is contained within the hand piece body 16 adjacent its distal end 20. A first fluid passageway 24 fluidly connects the mixing chamber 20 with a first port 26 formed at the distal end 20 of the hand piece body 16.

A second fluid passageway 28 is formed through the hand piece body 16 between its proximal end 18 and the mixing chamber 22. A flexible fluid conduit 30 (FIG. 1) then fluidly connects the second passageway 28 to a pressurized source 32 of water. A valve 34 is fluidly connected in series between the source 32 of pressurized water and the fluid conduit 30.

Similarly, a third fluid passageway 36 also extends through the hand piece body 16 between its proximal end 18 and the mixing chamber 22. A flexible conduit 38 (FIG. 1) fluidly connects the third passageway 36 at the proximal end 18 of the hand piece body 16 with a pressurized source 40 of gas, such as air. A valve 42 is also fluidly connected in series between the pressurized gas source 40 and the fluid conduit 38.

Still referring to FIGS. 1 and 3, a fourth fluid passageway 44 is formed through the hand piece body 16 from its proximal end 18 and to a port 46 formed at the distal end 20 of the hand piece body 16. This fourth fluid passageway 44 is also connected by a flexible fluid conduit 48 to a pressurized source 50 of an abrasive material, such as sodium bicarbonate, intermixed with a gas, such as air. A valve 52 is fluidly connected in series between the abrasive material source 50 and the conduit 48.

As best shown in FIG. 3, the ports 26 and 46 at the distal end 20 of the hand piece body 16 are arranged so that effluent through these ports 26 and 46 intersect each other at a predetermined point 54 spaced from the distal end 20 of the hand piece body 16. The distance between the distal end 20 of the hand piece body 16 and the intersection point 54 of the effluent from the ports 26 and 46 is preferably relatively small, e.g. a tenth of an inch.

With reference to FIG. 1, a control circuit 60 controls the actuation of the valves 34, 42 and 52. The control circuit 60 not only controls the actuation of these valves 34, 42 and 52, but also the degree of actuation of these valves 34, 42 and 52. Consequently, the control circuit 60 controls not only whether or not material from the sources 32, 40 and 50 are delivered through their respective ports 26 and 46 at the distal end 20 of the hand piece body 16, but also the amount of water, gas or abrasive particle stream that is delivered by the hand piece 14 through the ports 26 and 46.

With reference now particularly to FIG. 2, the hand piece 14 may be of either a one-piece construction 14 or may include a longitudinally aligned main part 62 and a detachable tip 64 which are selectively coupled together. In some instances, it may be desirable to use different types, configurations and/or shapes of the tip 64 while using the same main part 62 of the hand piece 14.

In operation and assuming that the control circuit 16 opens all three valves 34, 42 and 52, water from the source 32 and gas from the source 40 are simultaneously supplied to the mixing chamber 20 and intermixed together. The resulting gas/water mixture then exits from the mixing chamber 22 as an effluent from the port 26.

Simultaneously, abrasive material from the source 50 is delivered in the form of an abrasive material laden gas stream through the port 46 on the distal end 20 of the hand piece 14. The effluent of the abrasive material as well as the effluent from the mixing chamber 22 intersect at the point 54.

The dentist, through manipulation of the hand piece 40, is able to control the type of cleaning/cutting operation performed by the hand piece 14. For example, by moving the distal end 20 of the hand piece 14 closer to the work field, the dentist can achieve a dental procedure in which the abrasive particle laden stream from the source 50 first contacts the work field thus resulting in relatively high cutting action of the tooth material in the work field. In this instance, the gas/water stream from the mixing chamber 22 serves to capture the abrasive particles after impact on the dental material.

Conversely, by moving the distal end 20 of the hand piece 14 away from the work field, the abrasive material laden stream from the source 50 is first intermixed with the gas/water stream from the mixing chamber 22 thus forming a slurry prior to impact of the resulting slurry on the tooth material. Such a slurry can advantageously be used for tooth cleaning and other procedures where only minimal or no cutting of the tooth material is desired.

Additionally, the control circuit may be activated to selectively shut off the valve 52 and valve 42 so that only water from the water source 32 is provided from the port 26. Such a situation would be used where cleaning of the work area prior to resuming the dental procedure is desired.

Similarly, if desired, pressurized gas from the source 40 may alone be provided to the distal end 20 of the hand piece 14 for any desired purpose, such as drying of the work field. Likewise, if desired, the valves 34 and 42 may be closed such that the hand piece 14 delivers only an abrasive material laden stream from the source 50 where high cutting of the tooth material is desired.

From the foregoing, it can be seen that the present invention provides a simple and yet highly effective dental system having a unique hand piece which may be easily controlled and manipulated to perform many different types of dental procedures. Having described my invention, however, many modifications thereto will become apparent to those skilled in the art to which it pertains without deviation from the spirit of the invention as defined by the scope of the appended claims.

1. A dental handle piece for use in conjunction with a source of pressurized water, a source of pressurized gas and a source of abrasive material comprising:
an elongated body having a proximal end and a distal end, said body having an internal mixing chamber, said mixing chamber being fluidly connected to a first outlet port at said distal end of said body by a first fluid passageway,
a second fluid passageway formed in said body, said second fluid passageway having one end adapted for connection to the pressurized water source and a second end connected to said mixing chamber,
a third fluid passageway formed in said body, said third fluid passageway having one end adapted for connection to the pressurized gas source and a second end connected to said mixing chamber,
a fourth fluid passageway formed in said body, said fourth fluid passageway having one end adapted for connection with the source of abrasive material and a second end connected to a second port at a distal end of said body,
wherein said first and second ports are oriented on said body so that effluent from said first and second ports intersect each other at a predetermined distance from said distal end of said body.

2. The invention as defined in claim 1 wherein said body comprises a main part extending between said proximal end of said body and an intermediate position along said body, and a tip extending from intermediate position and said distal end of said body, said main part and said tip being removably attached together.

3. The invention as defined in claim 1 wherein said mixing chamber is spherical in shape.

4. The invention as defined in claim 2 wherein said mixing chamber is formed in said tip.

5. A dental system comprising:
a source of pressurized water,
a source of pressurized gas,
a source of abrasive material,
a hand piece including an elongated body with a proximal end and a distal end, said body having an internal mixing chamber, said mixing chamber being fluidly connected to a first outlet port at said distal end of said body by a first fluid passageway,
a second fluid passageway formed in said body, said second fluid passageway having one end adapted for connection to said pressurized water source and a second end connected to said mixing chamber,
a third fluid passageway formed in said body, said third fluid passageway having one end adapted for connection to said pressurized gas source and a second end connected to said mixing chamber,
a fourth fluid passageway formed in said body, said fourth fluid passageway having one end adapted for connection with said source of abrasive material and a second end connected to a second port at a distal end of said body,
wherein said first and second ports are oriented on said body so that effluent from said first and second ports intersect each other at a predetermined distance from said distal end of said body.

6. The invention as defined in claim 5 and comprising a valve fluidly connected in series between said water source and said second passageway.

7. The invention as defined in claim 6 and comprising a second valve fluidly connected in series between said gas source and said third passageway.

8. The invention as defined in claim 6 and comprising a third valve fluidly connected in series between said abrasive material source and said fourth passageway.

9. The invention as defined in claim 8 and comprising a control circuit which selective controls actuation of said first, second and third valves.

10. The invention as defined in claim 5 wherein said gas source comprises a pressurized air source.

11. The invention as defined in claim 5 wherein said abrasive material comprises sodium bicarbonate.

12. A method for removing tooth material from a target site comprising the steps of:
directing an abrasive laden gaseous stream onto the target site,
simultaneously directing a water stream onto the target site so that said abrasive laden gaseous stream and said water stream intersect at the target site.
